(19) United States
(12) Patent Application Publication
(10) Pub. No.: US 2007/0142093 A1
(43) Pub. Date: Jun. 21, 2007

(54) Portable terminal, data input device of the portable terminal, and its data input supporting method and data input supporting program

(75) Inventors: Muneyoshi Mikuni, Tokyo (JP); Aya Yamazaki, Tokyo (JP); Ken-ichiro Matsushita, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/638,362

(22) Filed: Dec. 14, 2006

(30) Foreign Application Priority Data
Dec. 16, 2005 (JP) 2005-364063

(51) Int. Cl. H04B 1/38; H04M 1/00

(52) U.S. Cl. 455/566

(57) ABSTRACT

It provides a portable terminal in which a user can directly operate an operation unit while looking at a display unit, in a folding state, without concentrating on the operation unit. The mobile phone is designed so that the operation body and the display body are connected at the hinge portion in a rotative way and it can be transformed from the state where the operation body and the display body fold together in a closed state to the state where the operation body and the display body are open nearly at the angle of about 180°. Key functions depending on the processing condition of the mobile phone are set at the respective keys of the input operation unit and the contents of the key functions are displayed on the display unit overlapping the image of the keys.

### BACKGROUNDS OF THE INVENTION

1. Field of the Invention

The invention relates to a portable terminal, and more particularly it relates to a portable terminal, a data input device of the portable terminal, its data input method, and its data input supporting program which can perform various operations such as input operation even in a folding state.

2. Description of the Related Art

As a conventional portable terminal such as a portable mobile phone, foldable terminals are widespread.

In the conventional foldable portable terminal, generally, a display unit formed by a liquid display and an operation unit for entering data or instructions are connected by a hinge portion, a display screen of the display unit and an input surface of the operation unit fold together at the hinge portion in a facing way, and at a time of use, the display and the operation unit are open substantially at the angle of 180°, so as to perform an operation for phone call and information communication by pushing various keys provided on the operation unit.

Further, there has been proposed such a portable terminal designed into a double hinge structure with another hinge vertically provided with the hinge portion for opening and closing the display unit and the operation unit and in such a way that the display unit is twisted around the vertical hinge so that the display screen of the display unit can be seen outwardly even in a folding state.

Further, Japanese Patent Publication Laid-Open No. 2004-185090 (Patent Document 1) discloses a portable terminal designed in that a display unit and an operation unit are rotated around the hinge portion substantially at the angle of 360°. According to the portable terminal of Patent Document 1, the display unit and the operation unit can fold together not only in a facing way but also in an opposite way, in addition to the open state of the display unit and the operation unit.

Patent Document 1 Japanese Patent Publication Laid-Open No. 2004-185090

The above mentioned conventional techniques have the following problems.

In the conventional portable terminal, each key function is fixedly assigned to each key arranged in the operation unit and a user generally operates the terminal while confirming the contents (processing and characters) of a key function attached to each key top of the operation unit. This often takes the user's eyes off away from the screen during the operation and it is difficult to perform a key operation smoothly while looking at the screen.

In the conventional general foldable portable terminal, a display screen of the display unit is hidden in a folding state and it is impossible to carry out the original functions excepting a specified function in a folding state.

Specifically, although an easy function such as confirmation of reception can be carried out in a folding state by using a small sub-display provided on the rear surface of the display unit and the operation button provided on the side portion of the body, it is necessary to open the display unit and the operation unit in order to use the original functions of the portable terminal.

Further, in the case of the portable terminal designed in the double hinge structure in which the vertical hinge is provided with the hinge portion for opening and closing the display unit and the operation unit, hence to enable the display unit to twist around the vertical hinge, the portable terminal can be folded with the display screen of the display unit seen outward but the operation unit is hidden inwardly by the display unit. Similarly, it is limited to the easy operation using the operation button on the lateral side of the body and the original functions by using the operation unit cannot be carried out.

Further, in the portable terminal disclosed in Patent Document 1, when the display unit and the operation unit are opened at the angle of 360° and fold together in an opposite way with their rear surfaces coming into contact, each of the display unit and the operation unit can be facing outwardly but it is impossible to directly operate the operation unit while looking at the display unit because the operation unit is facing oppositely.

Namely, in the portable terminal of Patent Document 1, the display unit can be only folded outwardly without having the double hinge structure, but it has the same problem.

An object of the invention is to solve the above conventional problems and to provide a portable terminal, a data input device of the portable terminal, its data input method, and its data input supporting program in which a user can perform an operation for entering processing and character smoothly while looking at a screen without too much concentrating on the keys on the operation unit with his or her eyes off away from the screen.

Another object of the invention is to solve the above conventional problems and to provide a portable terminal, a data input device of the portable terminal, its data input method, and its data input supporting program in which a user can perform the original functions of the portable terminal while operating the operation unit even in a folding state.

Further another object of the invention is to provide a portable terminal, a data input device of the portable terminal, its data input method, and its data input supporting program in which a user can enter data with the operation unit while looking at the display unit without looking at the operation unit carefully.

### SUMMARY OF THE INVENTION

According to the invention to solve the above problems, a portable terminal having a display body including a display unit and an operation body including an input operation unit is characterized by comprising a means of assigning predetermined key functions to a plurality of key portions provided on the input operation unit, depending on the current processing condition and a means of displaying the contents of the key functions assigned to the key portion, on the display unit.

According to the invention, the display body including the display unit and the operation body including the input operation unit are supported by the hinge in an opening and closing way and they are in a closed state by folding together with their rear surfaces into contact.

According to the invention, the input operation unit is the single bodied operation key working as the push button key and formed by the operation key on which surface a plurality of key portions capable of entering information through a touch are arranged.

According to the invention, the key function assigning unit assigns the predetermined key functions to the key portions and the push button function of the operation key forming the input operation unit, and the key function displaying unit displays the contents of the key functions overlapping the image of the key portions of the operation key.

According to the portable terminal of the invention, the predetermined key functions are assigned to the key portions of the operation key on the input operation unit, depending on the current processing condition, and the contents of the assigned key functions are displayed on the display unit overlapping the image of the key portions of the operation key. Therefore, it is possible for a user to perform an input operation while confirming the image of the operation key and the assigned key functions displayed on the display unit even in a folding state of the portable terminal in the same way as in an open state.

According to the portable terminal of the invention, it is possible to perform an input operation freely while looking at the display unit without looking at the operation key on the input operation unit, which enables a smooth operation of a terminal.

According to the portable terminal of the invention, even in a folding state of the portable terminal, a user can perform an input operation freely and use the original functions while looking at the display unit, in the same way as in an open state.

This is because depending on the current processing condition of the portable terminal, the predetermined key functions are assigned to the key portions on the operation key of the input operation unit and the contents of the key functions assigned to the key portions on the operation key are displayed on the display unit in an overlapping way.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is an appearance view showing the state in which a portable terminal according to a first embodiment of the invention is open;

FIG. 2 is an appearance view on the side of an input operation unit in a folding state of the mobile phone according to the first embodiment;

FIG. 3 is an appearance view on the side of a display unit in a folding state of the mobile phone according to the first embodiment;

FIG. 4 is a view showing the cross sectional structure of the input operation unit of the mobile phone according to the first embodiment;

FIG. 5 is an appearance view showing the input operation unit of the mobile phone according to the first embodiment;

FIG. 6 is a block diagram showing the hardware structure of the mobile phone 1 according to the first embodiment;

FIG. 7 is a block diagram showing the whole functional structure of the mobile phone 1 according to the first embodiment;

FIG. 8 is a view showing the structure of the input operation unit and an input supporting unit of the mobile phone according to the first embodiment;

FIG. 9 is a block diagram showing the functional structure of the input supporting unit according to the first embodiment;

FIG. 10 is a view showing an example of a processing condition/key setting correspondence table used for the mobile phone according to the first embodiment;

FIG. 11 is a view showing an example of a key setting table used for the mobile phone according to the first embodiment;

FIG. 12 is a view showing an example of a display parameter table used for the mobile phone according to the first embodiment;

FIG. 13 is a view showing an example of a reverse key setting table used for the mobile phone according to the first embodiment;

FIG. 14 is a view showing an example of assignment of key functions set by a key function setting unit according to the first embodiment and its display example on the display;

FIG. 15 is a view showing an example of assignment of the key functions set by the key function setting unit according to the first embodiment and its display example on the display;

FIG. 16 is a view showing an example of assignment of the key functions set by the key function setting unit according to the first embodiment and its display example on the display;

FIG. 17 is a view showing an example of definition in the key setting table 222 used for the assignment of the key functions shown in FIG. 16;

FIG. 18 is a view showing an example of assignment of the key functions set by the key function setting unit according to the first embodiment and its display example on the display;

FIG. 19 is a view showing an example of definition in the key setting table 222 used for the assignment of the key functions shown in FIG. 18;

FIG. 20 is a view showing an example of assignment of the key functions set by the key function setting unit according to the first embodiment and its display example on the display;

FIG. 21 is a view showing an example of definition in the key setting table 222 used for the assignment of the key functions shown in FIG. 20;

FIG. 22 is a view showing an example of definition in the key setting table 222 used for the assignment of the key functions shown in FIG. 29;

FIG. 23 is a flow chart showing the operation of mobile phone 1 according to the first embodiment;

FIG. 24 is a flow chart for use in describing the operation of the recognizing processing of key entry by an input recognizing unit;

FIG. 25 is a flow chart for use in describing another operational example of the recognizing processing of key entry by the input recognizing unit;

FIG. 26 is a flow chart for use in describing the character input operation of the mobile phone 1 according to the first embodiment;

FIG. 27 is a view for use in describing the concrete operational example of the input operation of the mobile phone 1 according to the embodiment;

FIG. 28 is a view for use in describing the concrete operational example of the input operation of the mobile phone 1 according to the embodiment;

FIG. 29 is a view for use in describing the concrete operational example of the input operation of the mobile phone 1 according to the embodiment;

FIG. 30 is a view for use in describing the concrete operational example of the input operation of the mobile phone 1 according to the embodiment;

FIG. 31 is a view for use in describing the concrete operational example of the input operation of the mobile phone 1 according to the embodiment; and

FIG. 32 is a view showing an example of the reversed display of the key functions set by the key function setting unit according to the first embodiment.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

Hereinafter, preferred embodiments of the invention will be described in detail referring to the drawings.

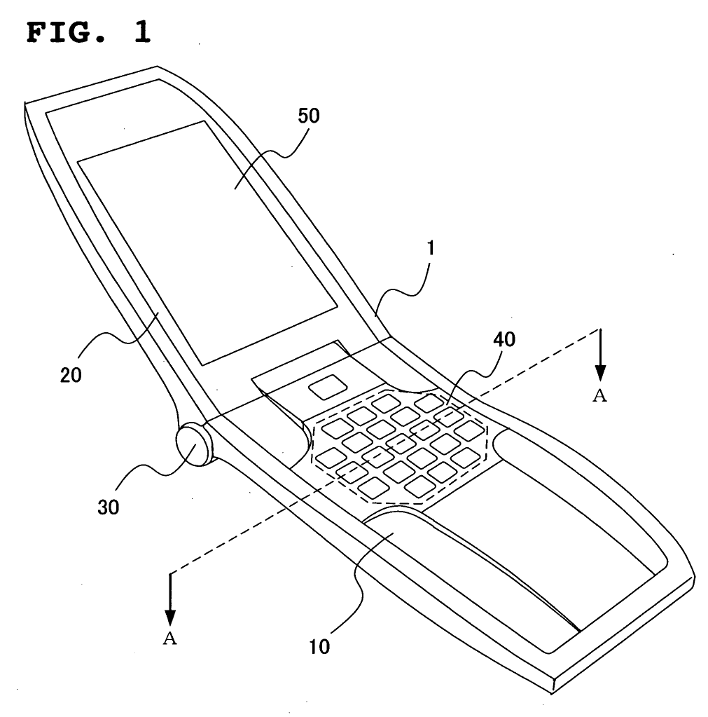

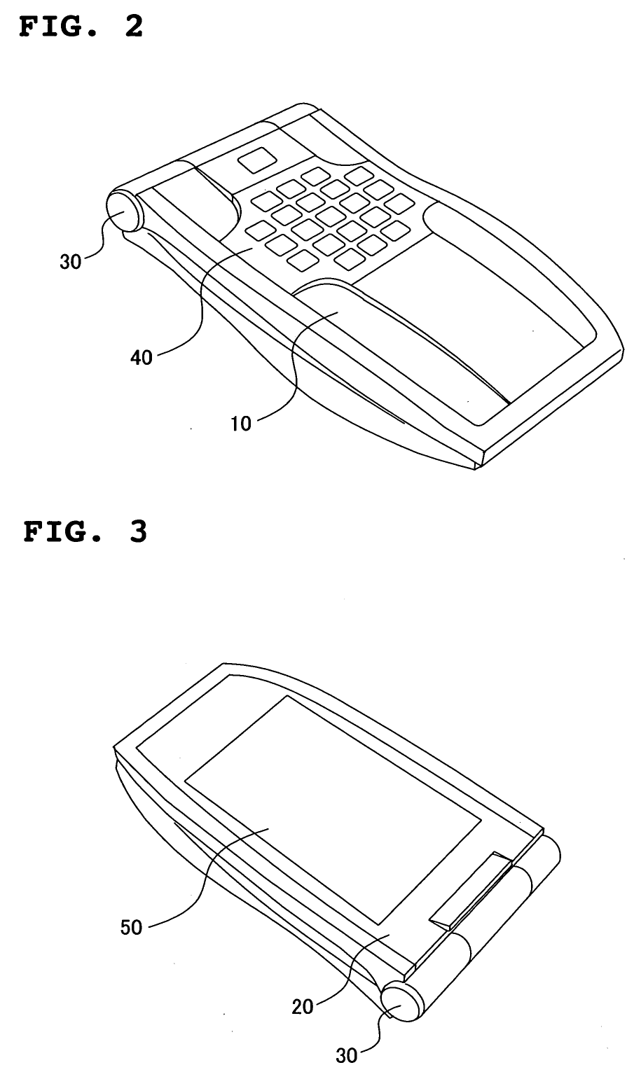

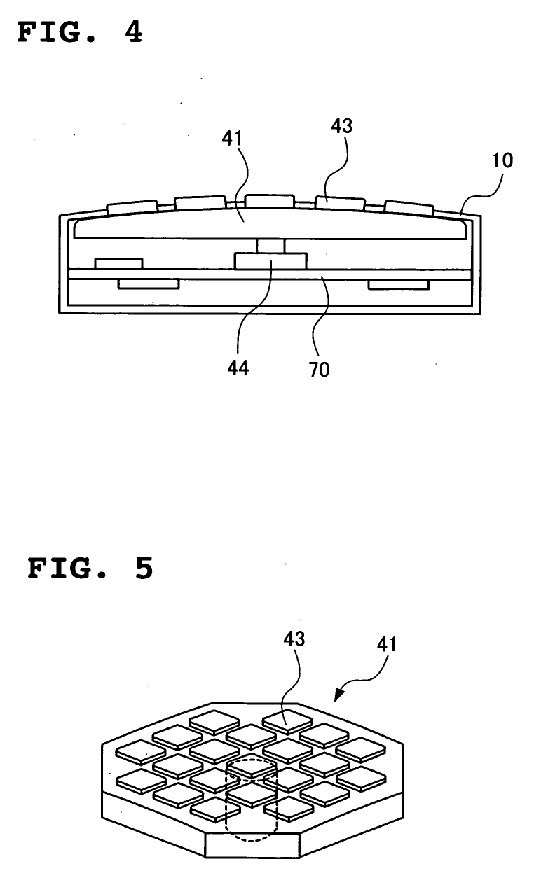

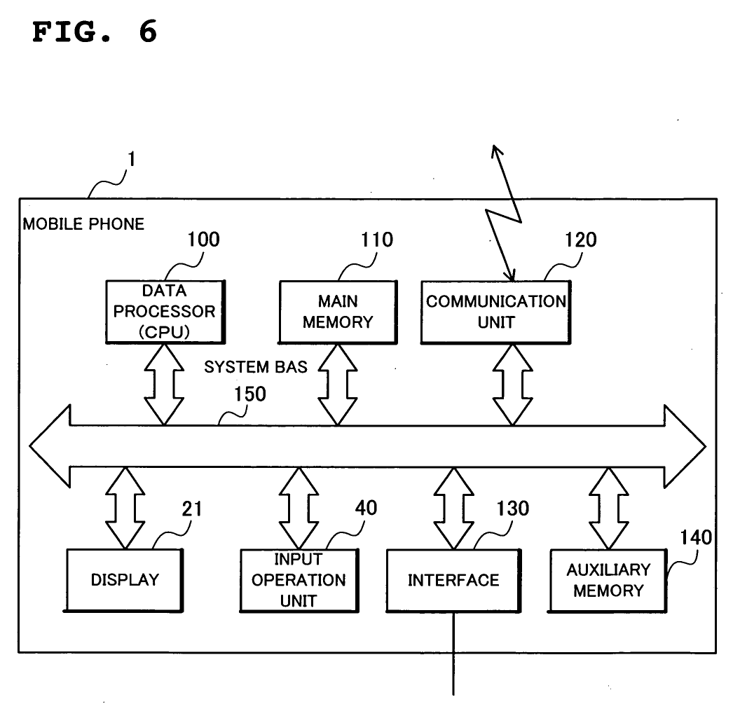

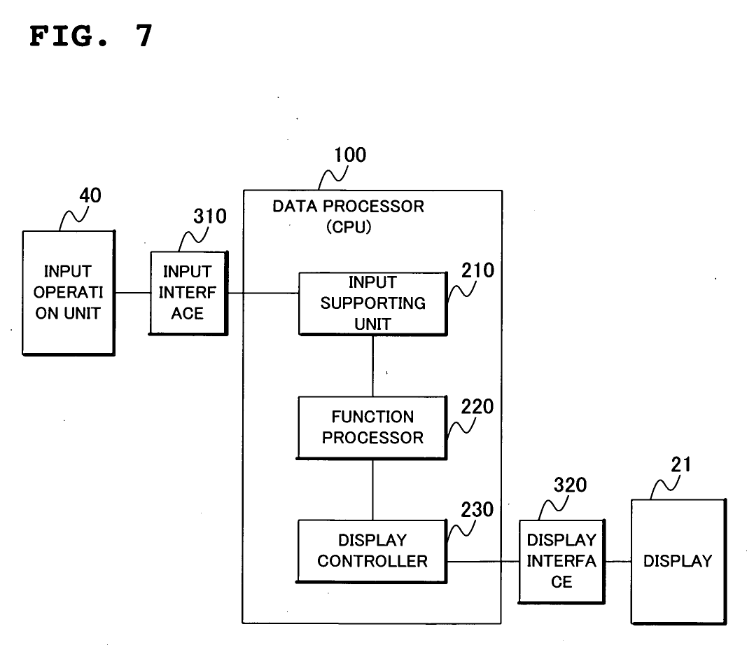

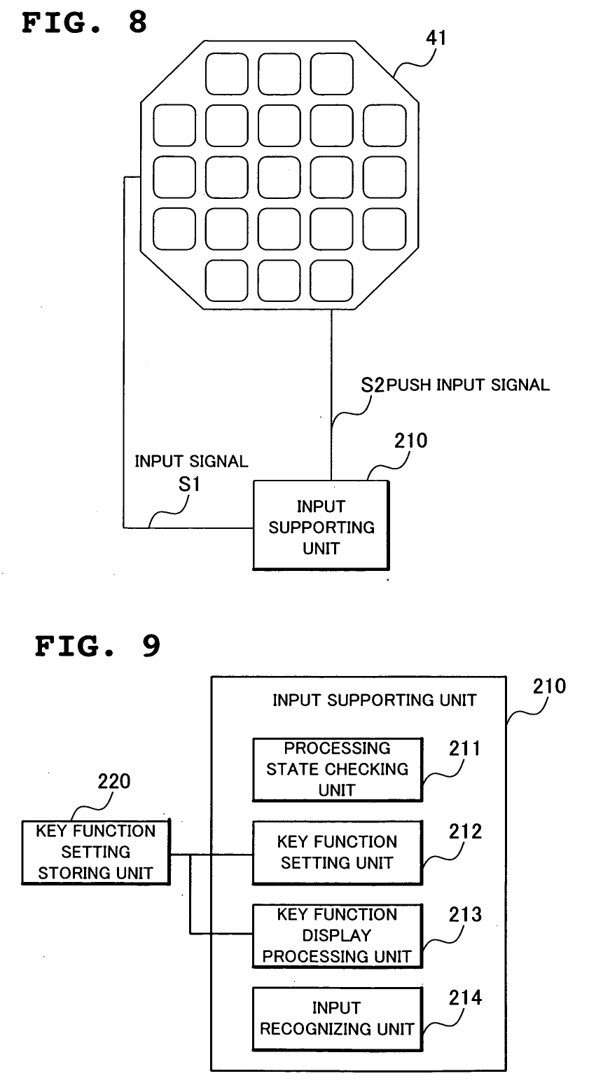

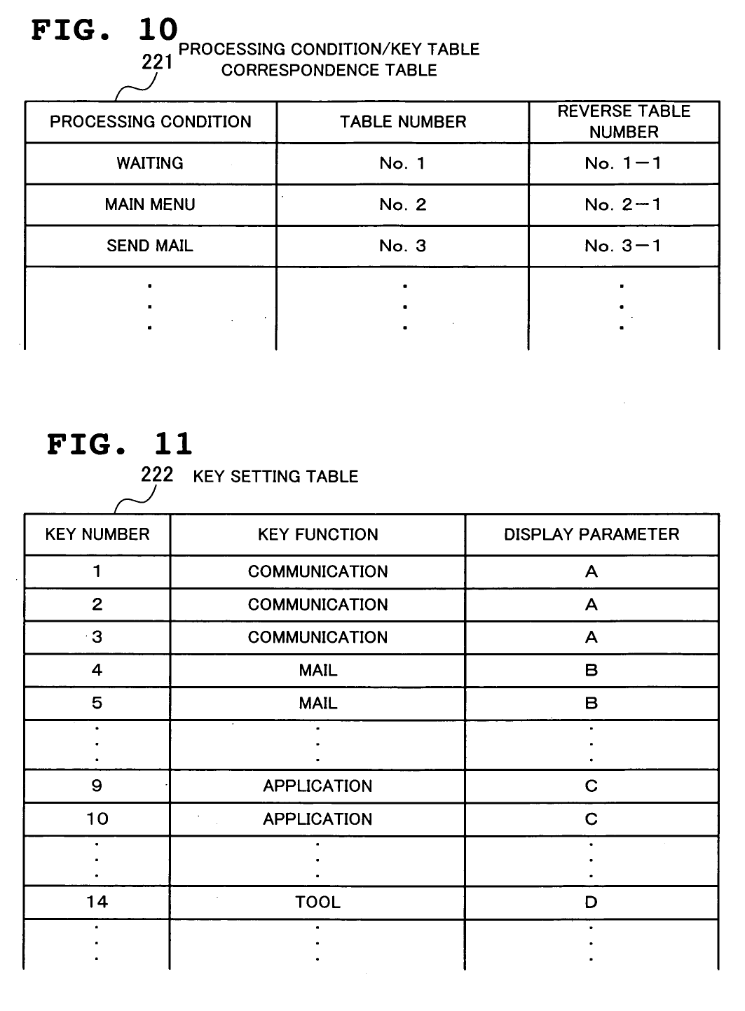

FIG. 1 is an appearance view of a portable terminal according to the first embodiment of the invention. This embodiment shows the case where the invention is applied to a mobile phone 1 as the portable terminal.

The mobile phone 1 according to the embodiment has a general communication function, a time display function, a call history managing function, and a mail function by application, and it is designed in that an operation body 10 is connected to a display body 20 through a hinge portion 30 in a rotative way.

The mobile phone 1 varies from a closed state to an open state by rotating the operation body 10 and the display body 20 around the hinge portion 30 within the range of about 180°.

FIG. 2 is an example showing the closed state of the mobile phone 1 according to the embodiment.

This mobile phone 1 can be transformed from a state where the operation body 10 and the display body 20 fold together as illustrated in FIG. 2 and FIG. 3 to a state where the operation body 10 and the display body 20 are open at the angle of about 180° as illustrated in FIG. 1.

The operation body 10 is provided with an input operation unit 40 for entering data or instruction.

In the closed state of the mobile phone 1, the input operation unit 40 is arranged at a position opposite to a display 50 of the display body 20, as illustrated in FIG. 2 and FIG. 3.

The mobile phone 1 is designed so that the operation body 10 can be used for various operations in either position when the operation body 10 and the display body 20 are in an open state as illustrated in FIG. 1 or when the operation body 10 and the display body 20 fold together in a closed state as illustrated in FIG. 2 and FIG. 3.

FIG. 4 is a view showing the cross sectional structure of the input operation unit 40 of the operation body 10 in FIG. 1, and FIG. 5 is an appearance view of the input operation unit 40.

As illustrated in FIG. 5, the input operation unit 40 is integrally formed by a single bodied operation key 41 with its width close to the size of the operation body 10 and a plurality of input keys 43 arranged in a plurality of sub divisions formed on the surface of the operation key 10.

Each of the input keys 43 is realized by a touch sensitive key which can enter the information assigned to a corresponding key, sensing a finger touch there, or a pressure sensitive key which can enter the information assigned to a corresponding key, sensing a predetermined pressure and more added to the key by the finger.

The operation key 41 has a function as a push down button key such as a tact switch and the whole operation key 41 is supported by a shaft provided in its center on a switch portion 44 in a way capable of being pushed.

The operation key 41 is accommodated into the operation body 10 of the mobile phone 1, as illustrated in FIG. 4. The switch portion 44 of the operation key 41 is fixedly connected to a circuit board 70 including electronic parts such as LSI built in the operation body 10, and the input keys 43 on the surface of the operation key 41 are exposed to the outside through openings formed in the case of the operation body 10 correspondingly to the input keys 43.

Owing to the above structure of the input operation unit 40, touch input (touch input signal) is enabled through an operation of touching on and off the input key 43 by the finger or an operation of adding pressure, and push input (push input signal) is enabled through directly pushing down the input key 43.

In the push input, the whole operation key 41 can be pushed down with a push on any portion of the input keys 43 of the operation key 41.

The structure and the configuration of the operation key 41 forming the input operation unit 40 is not restricted to the structure and configuration shown in the drawings but various structures and configurations may be considered. For example, the configuration of the operation key 41 may be formed into not only a substantially rectangular shape as shown but also a circular or polygonal shape. The number of the input keys 43 of the operation key 41 and their arrangement are not restricted to those as shown in the drawings.

The hardware structure of the mobile phone 1 will be described here.

FIG. 6 is a block diagram showing the hardware structure of the mobile phone 1 according to the embodiment.

Referring to FIG. 6, the mobile phone 1 according to the embodiment may be realized by the same hardware structure as that of the general computer, and it comprises a data processor (CPU: Central Processing Unit) 100, a main memory 110 such as a RAM (Random Access Memory) used for a working area of data and a temporarily saving area of data, a communication unit 120 for transmitting and receiving voice and data, a display 50 such as a liquid crystal display, the input operation unit 40 which is a feature structure of the invention, an interface 130 connected to a peripheral equipment for transmitting and receiving data, an auxiliary memory 140 that is a hard disk, including a ROM (Read Only Memory), a magnetic disk, and a non-volatile memory such as a semiconductor memory, and a system bus 150 for mutually connecting each of the above components of this information processor.

The function of the mobile phone 1 according to the embodiment may be realized, needless to say, in a hardware way that the circuit parts consisting of the hardware parts such as LSI (Large Scale Integration) is mounted, with a program for realizing various functions built in the mobile phone 1, and also in a software way that a program providing various functions of the above components is executed by the data processor (CPU) 100 on the computer.

Namely, the data processor (CPU) 100 realizes the above mentioned respective functions in a software way that the program stored into the auxiliary memory 140 is executed by loading it into the main memory 110 hence to control the operation of the mobile phone 1.

FIG. 7 is a block diagram showing the function of the mobile phone 1 according to the embodiment, and the data processor (CPU) 100 of the mobile phone 1 includes the input supporting unit 210, a function processor 220, and a display controller 230.

The input supporting unit 210 is connected to the input operation unit 40 through an input interface 310. The display controller 230 is connected to the display 50 through a display interface 320.

The input supporting unit 210 provides some functions to add the original operationality of the invention by supporting an input operation using the input operation unit 40.

The function processor 220 is to realize various functions including a call function, a data transmitting and receiving function, an application execute function, and an edit function of data including a phone book, that are the functions originally provided in the mobile phone 1.

The display controller 230 is to control the display of letters and images shown on the display 50, and in the embodiment, further, it has a role of displaying each key function assigned to each of the input keys 43 based on the setting by the input supporting unit 210 and their arrangement on the display 50.

As illustrated in FIG. 8, the operation key 41 supplies an input signal S1 entered through the operation (touch operation or push operation) of the input key 43 and a push input signal S2 through the push operation of the input key 43, to the input supporting unit 210.

The structure of the input operation unit 40 and the input supporting unit 210 of the mobile phone 1 will be described with reference to FIG. 8 and FIG. 9.

As illustrated in FIG. 8, the input keys 43 of the operation key 41 in the input operation unit 40 are different from the switch keys provided on the general type of the portable terminal and the respective functions of the respective keys are not fixed physically, but each key function is switched depending on the current condition of processing in every input key 43 or in every group of the input keys 43 when grouping the input keys.

Namely, in this type of the general mobile phone, each predetermined key function is previously assigned to each arranged key and a letter or a symbol indicating the corresponding function is attached there. The mobile phone according to the embodiment, however, does not have to attach such a letter or symbol for specifying the function contents to the input key 43.

Further, it is designed in that a specified key function can be set not only at each individual input key 43 but also at each combination (group) of some input keys 43 (for example, in a rang of one row or one column).

A touch input and a push input through the input key 43 of the operation key 41 transfers the input information corresponding to the key function assigned to the same key to the input supporting unit 43.

The input supporting unit 210 is realized by firmware or software, and it has a function of setting the assignments of the push functions to the operation key 41 and the assignments of the respective key functions to the respective input keys 43 according to the processing condition and getting the information entered according to the set key function assignments.

As illustrated in FIG. 9, the input supporting unit 210 according to the embodiment comprises a processing condition checking unit 211, a key function setting unit 212, a key function display processing unit 213, an input recognizing unit 214, and a key function setting storing unit 220.

The processing condition checking unit 211 has a function of checking the current processing condition of the mobile phone 1 (for example, the initial processing condition or another processing condition after predetermined processing).

In other words, the processing condition checking unit 211 is to check what kind of input information is acceptable by the mobile phone 1.

The key function setting unit 212 has a function of setting the arrangement (range) of the keys and the key functions, with regard to the input keys 43 and the push key function of the operation key 41, according to the processing condition checked by the processing condition checking unit 211.

More specifically, based on the checked processing condition, the key function setting unit 212 sets each key function predetermined depending on the processing condition at each input key 43 or at each range of their combination (group of the input keys) and at the push key function, according to the contents defined in various kinds of tables stored in the key function setting storing unit 220.

Here, the key function is a predetermined function to be processed corresponding to the information input through the push operation of the operation key 41 or the touch operation of the input key 43.

The key function setting storing unit 220 previously stores a correspondence table 221 of processing condition and key setting, a key setting table 222, a display parameter table 223, and a reverse key table 224.

As illustrated in FIG. 10, the processing condition/key setting correspondence table 221 shows a correspondence between the table number and the reverse table number of the key setting table 222 where the key functions to be assigned are defined, in every current processing condition of the mobile phone 1 (waiting state, main menu, mail transmission, and so on).

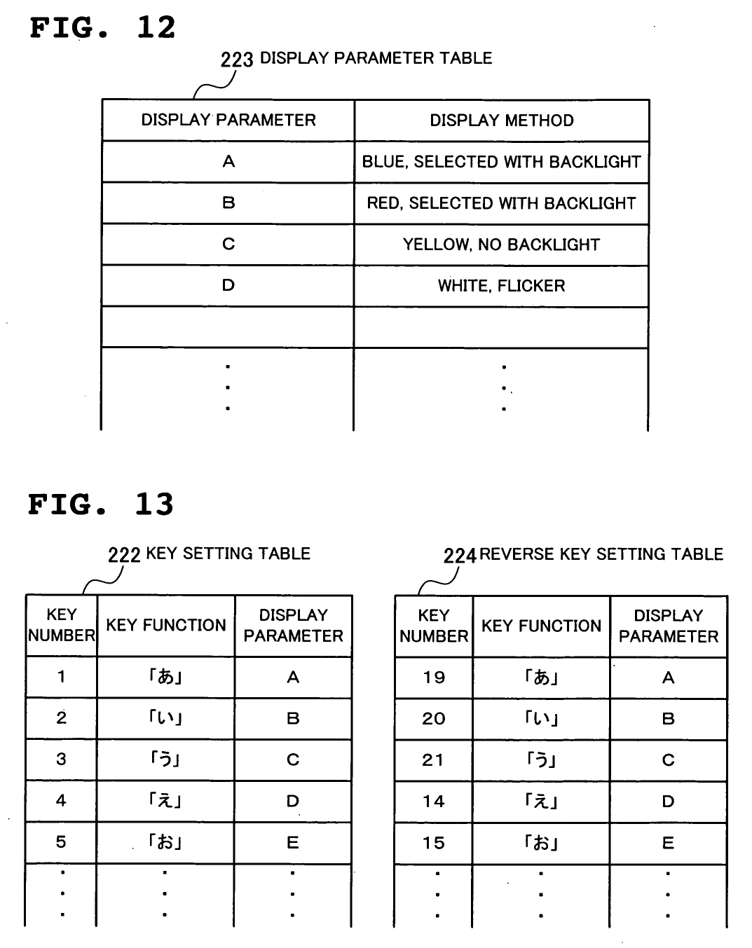

In the key setting table 222, each key function (processing contents and input characters such as alpha-numeral) to be assigned to each input key 43 and each display parameter are set in every key number of the respective input keys 43, as illustrated in FIG. 11.

The key numbers are assigned to the respective input keys 43 from the top, for example, in number order, as illustrated in FIG. 15. The numeral attached to each of the input keys 43 indicates the key number and the actual number is not attached to it.

The key setting tables 222 are prepared for the same number of the processing conditions defined in the processing condition/key setting correspondence table 221, and each of the tables has the table number (No. 1, No. 2, . . . ).

The display parameter is a parameter for indicating how to display the contents of a key function assigned to an input key 43 on the display 50, and each display method for controlling the display is defined for every parameter in the display parameter table 223.

FIG. 12 shows the display parameter table 223, where how to display the contents of a key function assigned to an input key 43 (display attribute including presence of the backlight, display color, presence of the flicker, and the like) is specifically defined in every display parameter (A, B, C, . . . ).

In the reverse key table 224 shown in FIG. 13, the setting contents of each key function when the whole input keys 43 are reversed up side down are defined for every key setting table 222.

The reverse key table 224 is a table for reversing the assignment of the key functions when the mobile phone turns from the open state to the closed state, which is prepared for every key setting table 222, with the reverse table number (No. 1-1, No. 2-1, attached.

Upon receipt of the processing contents checked by the processing condition checking unit 211, the key function setting unit 212 gets the table number with reference to the processing condition/key setting correspondence table 221 and assigns the key functions to the input keys 43 according to the contents defined in the key setting table 222 corresponding to the obtained key table number. In other words, it assigns the respective key functions defined in the respective key numbers of the key setting table 222 to the respectively corresponding input keys 43.

The key function display processing unit 213 has a function of displaying the contents of the key functions assigned in conformity with the image of the input keys 43 on the display 21, based on the assignment contents of the key functions set by the key function setting unit 212.

More specifically, the image of the input keys 43 in the input operation unit 40 is transparently displayed on the display 21 and simultaneously the contents of the key functions assigned to the input keys 43 are displayed overlapping the image of the input keys 43.

When displaying the key functions while overlapping the image of the input keys 43, the key function display processing unit 213 obtains the display parameter defined in the key setting table 222, with reference to the assigned key setting table 222, and displays the key functions according to the display method corresponding to this display parameter in the display parameter table 223.

The input recognizing unit 214 has a function of checking the existence of a key entry from the input operation unit 40 and a function of supplying the input information corresponding to the key function which is set at the input key 43 or the push button key by the key function setting unit 212, to the function processor 220 when there exists the key entry.

The key entry is checked by the input recognizing unit 214 according to the operation of selecting and determining the input key 43 described later.

The function processor 220 performs predetermined processing according to the input information (key operation information) sent from the input recognizing unit 214.

Various data to be communicated through the mobile phone 1 is displayed on the display 50 such as a liquid crystal display (LCD) in the display body 20 and a screen for supporting the entry by the input operation unit 40 is also displayed by the key function display processing unit 213.

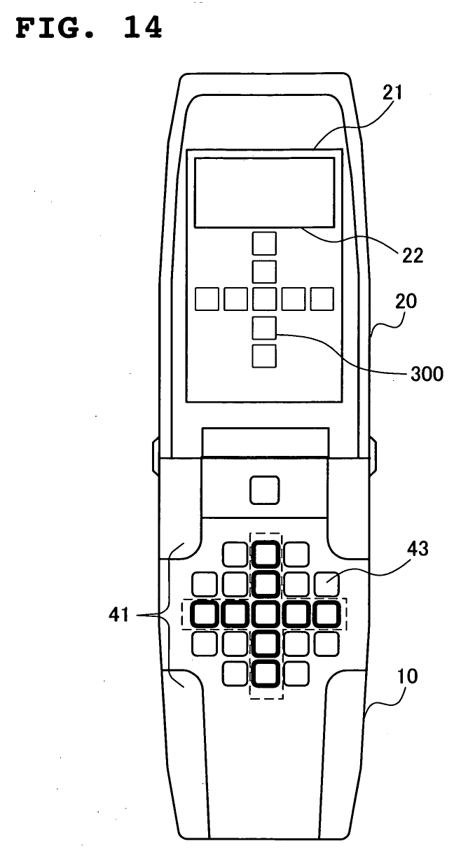

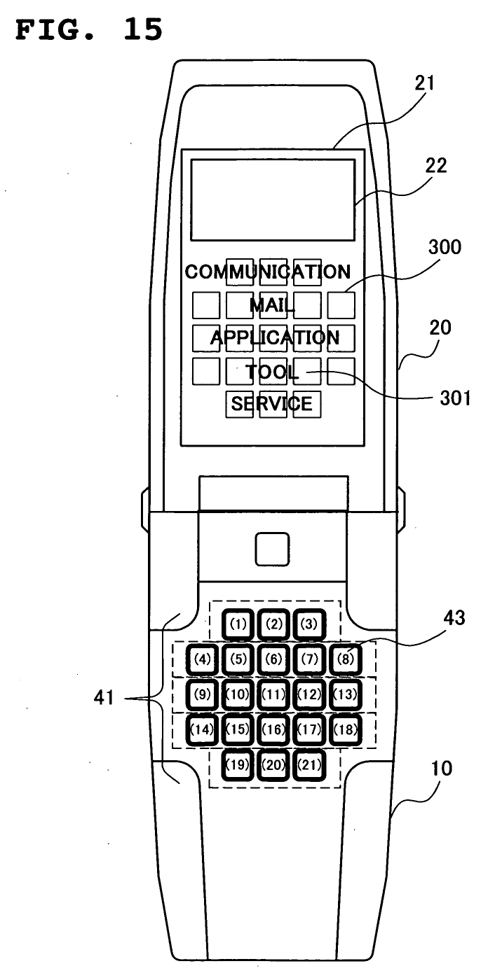

When a user enters the data through the input operation unit 40, an input display area 22 for displaying the input letter and the other information is arranged above the portion of displaying the contents of the key functions assigned to the input keys 43 in an overlapping way as a whole image, as illustrated in FIG. 14 to FIG. 17.

The image of the input keys 43 is transparently displayed on the display 21 in the same size as the actual input key 43 in one to one correspondence, and various information to be transferred or received by the mobile phone 1 is displayed in a way of overlapping the image of the input keys 43.

The key functions and their arrangement (range) set by the key function setting unit 212 will be described with reference to FIG. 14 to FIG. 17.

In FIG. 14, according to a predetermined processing condition, some key functions are set at a cross consisting of the input keys 43 in the middle vertical and horizontal lines, by the key function setting unit 212, and the image 300 corresponding to the middle-crossed input keys with the key functions set there is displayed on the display 21. In this state, even when a user touches any input key 43 other than these crossed input keys, there occurs no entry.

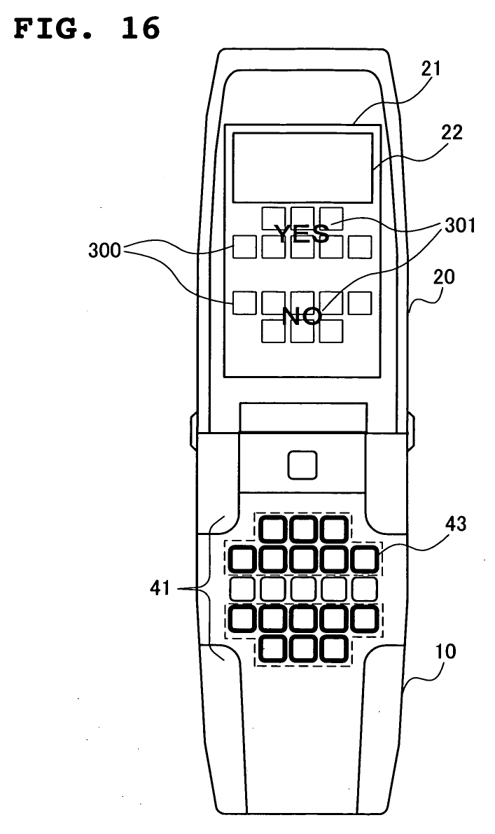

In FIG. 16, the key functions corresponding to the predetermined processing are set at the input keys 43 in the upper and lower portions excluding one middle line, by the key function setting unit 212.

In parallel with the key function assignment, the image 300 of these input keys 43 with the key functions assigned is transparently displayed on the display 21 and the key function information 301 indicating the contents of the key functions is displayed in the upper and lower portions having the key functions set.

In the example of FIG. 16, the key functions for entering “YES” and “NO” are respectively set in the upper portion and the lower portion and the key function information 301 (the letters of “YES” and “NO”) indicating the above is displayed.

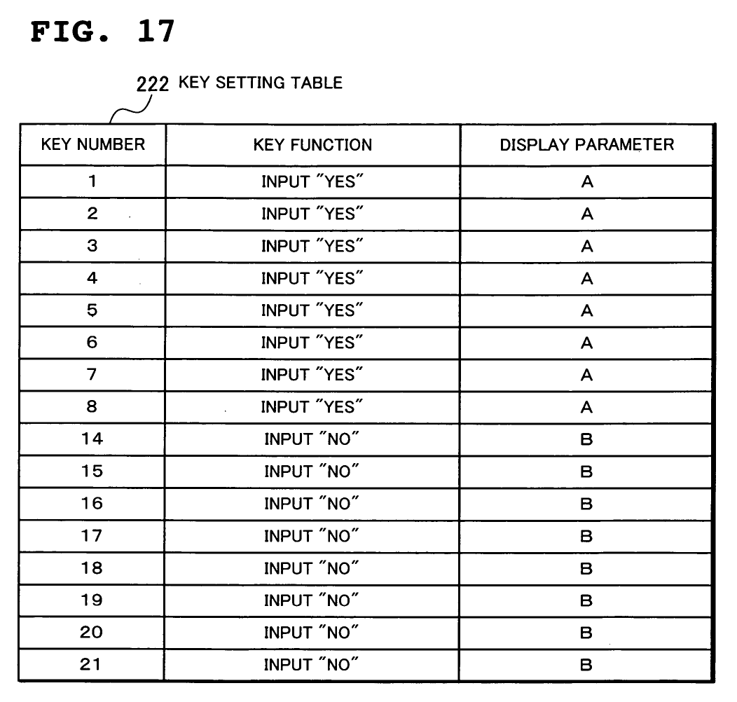

An example of definition in the key setting table 222 in this case is shown in FIG. 17.

In FIG. 15, the key functions corresponding to the predetermined processing conditions are set at the input keys 43 in five vertical lines by the key function setting unit 212.

In accordance with this assignment of the key functions, the display 21 transparently shows the image of the input keys 43 with the key functions assigned and also shows the key function information 301 indicating the contents of the key functions in the five lines.

FIG. 15 shows the example of the function selecting menu of the mobile phone 1 in five lines, with the respective key function information 301 (the letters of “call”, “mail”, “application”, “tool”, and “service”) shown as for the respective functions of performing the respective processing “call”, “mail”, “application”, “tool”, and “service”.

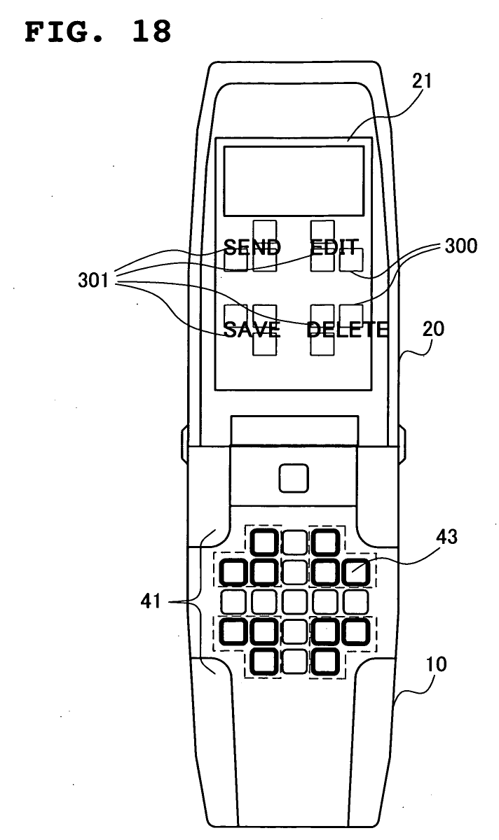

In FIG. 18, the key functions corresponding to the predetermined processing conditions are set at the input keys 43 in the four corners but the middle vertical and horizontal crossed lines, by the key function setting unit 212.

In accordance with the assignment of these key functions, the display 21 transparently shows the image 300 of the key portion with the key functions assigned, of all the input keys 43, and also shows the key function information 301 indicating the contents of these key functions in the four corners.

FIG. 18 shows the example of the functions for entering the respective processing “send”, “edit”, “save”, and “delete” with the respective key function information 301 (the letters of “send”, “edit”, “save”, and “delete”).

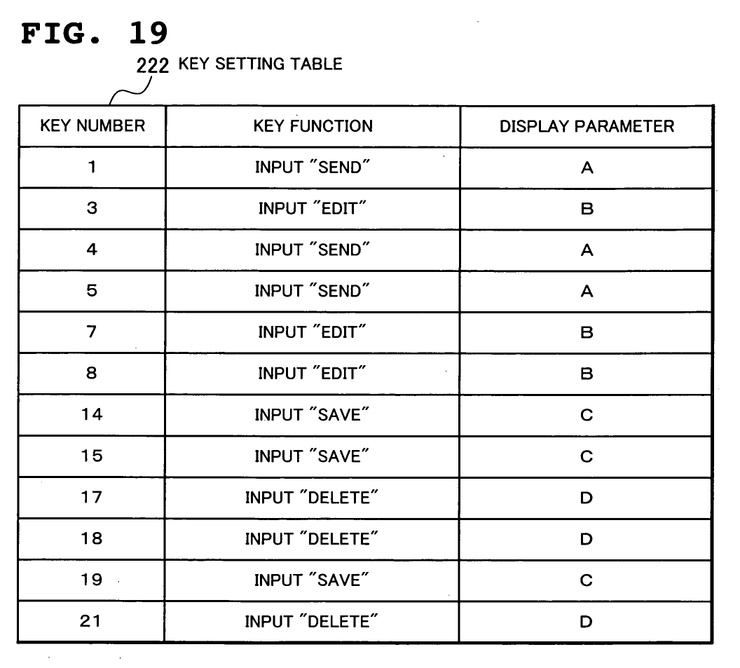

An example of the definition in the key setting table 222 in this case is shown in FIG. 19.

In FIG. 14 to FIG. 18, one key function may be assigned to the corresponding area, or the corresponding area may be divided into a plurality of small divisions and a plurality of the key functions may be assigned there.

The area corresponding to the assigned key functions, of the image 300 of the input keys 43 shown on the display 21, may be illuminated in several different colors by a back light and the like.

Although the setting of a key function for an input key 43 in the operation key 41 has been described in FIG. 15 to FIG. 18, a predetermined key function (for example, a function for deciding the input condition) is also set at a push button key according to the predetermined processing condition.

A concrete example of the screen displayed on the display 21 will be described referring to FIG. 20 and FIG. 29.

FIG. 20 shows an example of the contents of the key functions assigned to the respective input keys 43 of the input operation unit 40 and their display example on the display 21, when the operation body 10 and the display body 20 are opened, as illustrated in FIG. 1.

Namely, the key functions for entering Hirakana letters in the “A ( [symbol] )” line and the small “a ( [symbol] )” line of Hirakana are assigned as illustrated, with their key function information 301 displayed on the display 21 overlapping the image of the input keys 43.

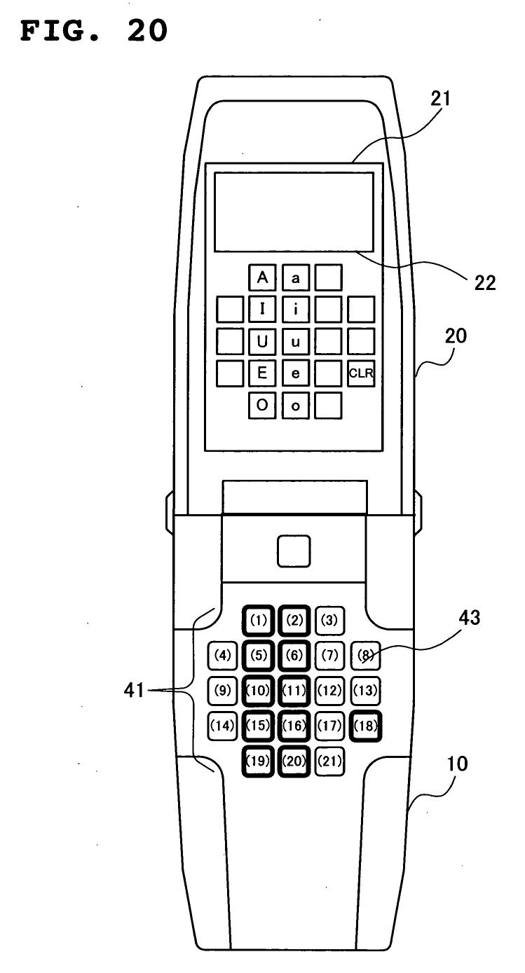

An example of the definition in the key setting table 222 in the case of FIG. 20 is shown in FIG. 21.

In FIG. 20, the input keys 43 with the key functions set are emphasized by a heavy line.

FIG. 29 shows a display example in the closed state of the operation body 10 and the display body 20 folding together as shown in FIG. 2, with the same key functions as those of FIG. 20 assigned there.

The left side of FIG. 29 shows the state of the operation body 10 and the operation key 41 transparently viewed from the side of the display body 20.

In the folding (closed) state of the mobile phone 1, a user performs an input operation while looking at display 21 by touching the input operation unit 40 of the operation body 10 positioned in the rear side of the mobile phone 1.

In this case, although the image of the input keys 43 shown on the display 21 and the contents of their key functions are the same as in the case of FIG. 20, the assignment of the input keys 43 to the input operation unit 40 in FIG. 20 is reversed upside down, as illustrated in FIG. 29. Namely, the key numbers of the respective input keys 43 of the input operation unit 40 which are positioned in the rear side in the folding state are reversed upside down from the open state, when they are viewed transparently from the side of the display 50.

For example, the letter “A ( [symbol] )” of Hirakana letter assigned to the input key 43 of the key number (1) in FIG. 20 is assigned to the input key 43 of the key number (19) in FIG. 29, in a way of reversing the assignment of the key functions to the input keys 43 upside down.

Owing to this, the reverse key setting table 224 as shown in FIG. 13 is previously defined, hence to make it easy to change the assignment of the key functions when moving to the folding state.

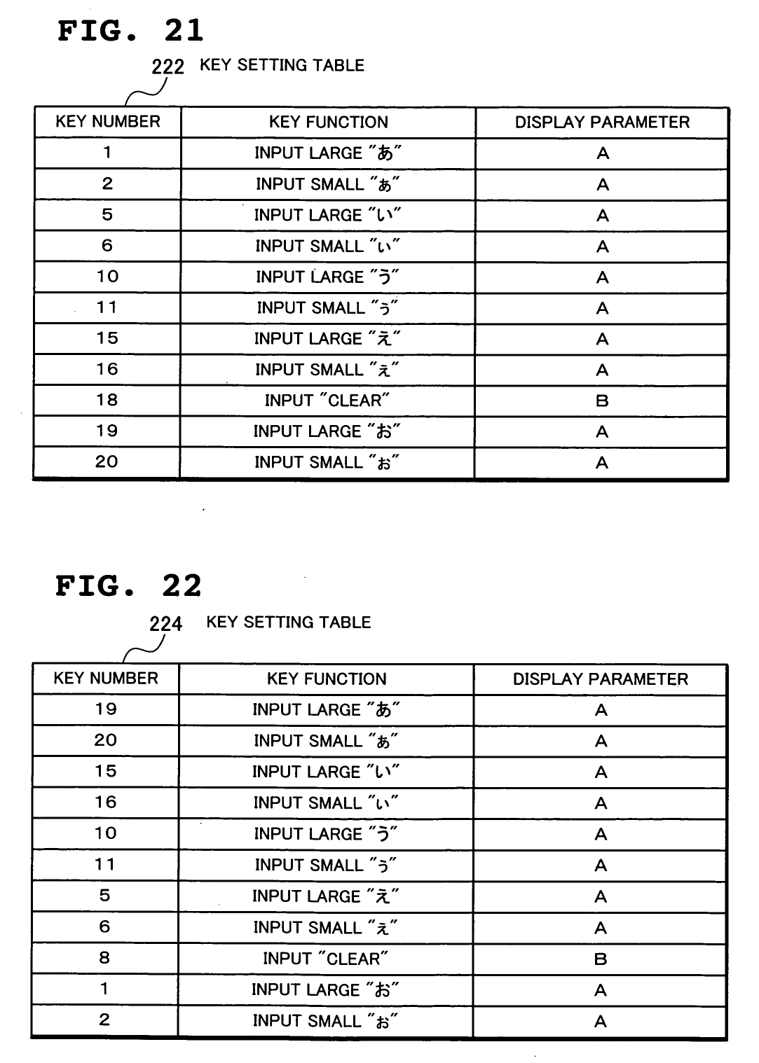

An example of the definition in the reverse key setting table 224 in the case of FIG. 29 is shown in FIG. 22.

According to the mobile phone 1 of the embodiment, it is possible to do an input operation both in the open state and the closed state of the operation body 10 and the display body 20 while looking at the key function display 301 displayed on the display 21.

The key function setting unit 213 of the input supporting unit 210 performs the reversing processing of the key function assignment to the input keys 43 between the open state and the closed state automatically depending on the state of the mobile phone 1 (open state or folding state).

In order to detect the state of the mobile phone 1, for example, a switch working together with the opening and closing or a sensor for detecting the angle may be provided in the hinge portion 30, to detect the open state and the closed state according to the angle between the operation unit 10 and the display 20.

(Operation of the First Embodiment)

FIG. 23 is a flow chart showing the operation of the input supporting unit 210 of the mobile phone 1 according to the embodiment.

With reference to FIG. 23, the mobile phone 1 according to the embodiment checks its own current processing condition by the processing condition checking unit 211 (Step S2301).

Based on the processing condition checked in Step S2301, the key function setting unit 212 obtains the table number of the key setting table 222 corresponding to the checked processing condition (Step S2303), referring to the processing condition/key setting correspondence table 221 of the key setting storing unit 220 (Step S2302).

It checks whether the mobile phone 1 is in the open state or in the closed state (Step S2304), and in the case of the open state, it reads the key setting table 222 shown by the table number and sets the key function according to the defined contents (Step S2305).

In the case of the closed state, it reads the reverse key setting table 224 shown by the reverse table number and sets the key functions according to the defined contents (Step S2306). Thus, the assignment of the key functions corresponding to the current processing condition is performed.

The key function display processing unit 213 obtains the display parameter (Step S2307) from the key setting table 222 which the key function setting unit 212 uses for assigning the key functions, obtains the display method (Step S2308) indicated by the display parameter obtained from the display parameter table 223, and displays the contents of the key functions (Step S2308) assigned by the key function setting unit 212 on the display 50 in a way of overlapping the image of the input keys 43, according to the obtained display method.

In this state, the input recognizing unit 214 checks whether or not there is a key entry from the input operation unit 40 (Step S2309), and when there is a key entry, it recognizes the input key function and supplies the input information corresponding to the key function to the function processor 220 (Step S2310).

Thus, the function processor 220 performs the predetermined processing based on the key input information sent from the input recognizing unit 214.

When the mobile phone 1 is closed from the open state, or opened from the closed state, the key function setting unit 212 and the key function display processing unit 213 execute the above mentioned steps, thereby performing the assignment of the key functions and the display of the assigned key functions.

Although the above description has been described in the case where a table for assigning the key functions in the open state of the mobile phone 1 is defined as the key setting table 222 and a table for assigning the key functions in the closed state is defined as the reverse key setting table 224, the table in the closed state may be defined as the key setting table 222 and the table in the open state may be defined as the reverse key setting table 224.

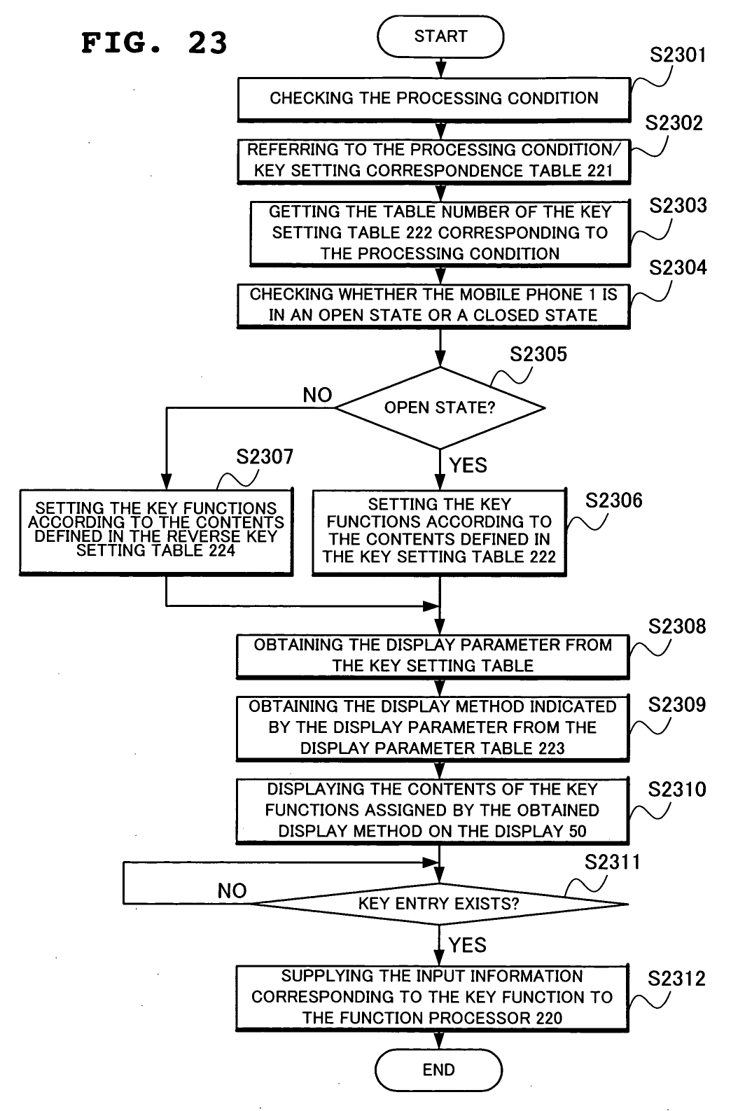

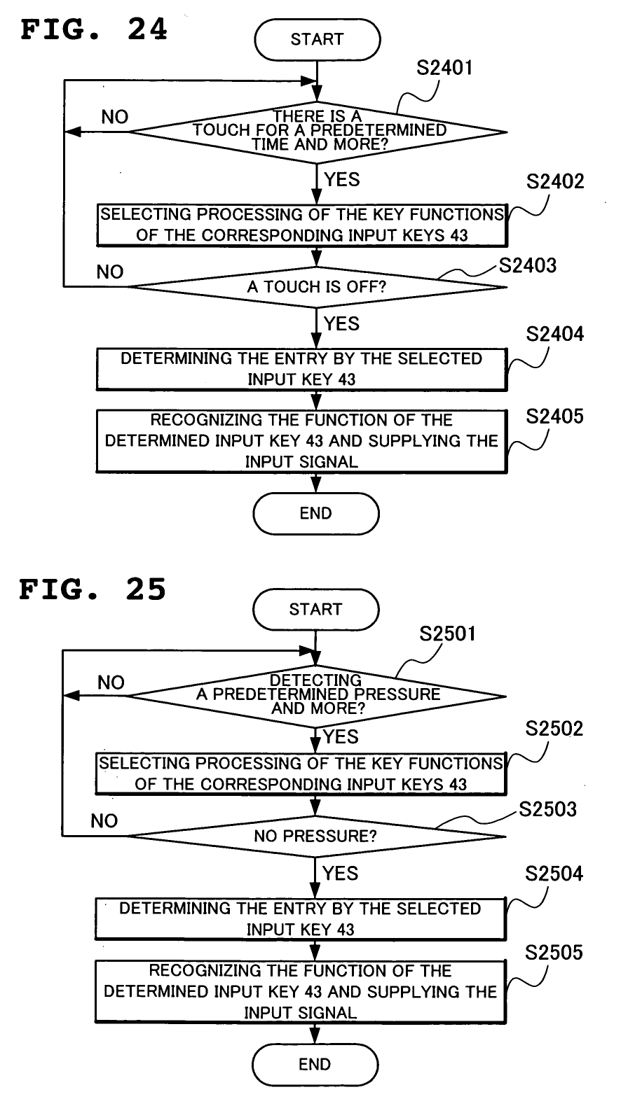

The operation of recognizing a key entry by the input recognizing unit 214 will be described according to the flow charts of FIG. 24 and FIG. 25.

FIG. 24 shows the recognition processing of the key entry when a touch sensitive key sensing a finger's touch is used as the input key 43 of the operation key 41, which enables the input of the corresponding information assigned to the sensed key.

The input recognizing unit 214 constantly monitors the sensitive signals through touch from the input key 43 and checks whether the input key is touched continuously more than a predetermined time (Step S2401).

When it is touched continuously more than a predetermined time, the unit 214 performs the processing of selecting the corresponding key function of the input key 43 (Step S2402).

It checks whether the touch disappears through taking off a finger from the selected input key 43 in this state (Step S2403); when the touch no longer exists after taking off the finger from the input key 43, it decides the entry of the key function corresponding to the selected input key 43 (Step S2404), recognizes the function of the decided input key 43, and supplies the input signal (Step S2405).

Although the above description has been made in the case where the key function in the selected state is decided when the touch on the input key 43 disappears, the selected entry may be decided when the operation key 41 (the push button key) itself is pushed down in the selected state.

FIG. 25 shows the recognition processing of a key entry in the case of using a pressure sensitive key, as the input key 43 of the operation key 41, which enables the input of the information assigned to this key, sensing a predetermined pressure and more added there by the finger.

The input recognizing unit 214 constantly monitors pressure detective signals from the input keys 43 and checks whether a predetermined pressure and more is detected or not (Step S2501).

When it detects a predetermined pressure and more, the unit 214 performs the processing of selecting the corresponding key function of the input key 43 (Step S2502).

It checks whether the pressure disappears through taking off the finger from the selected input key 43 in this state; when the pressure disappears, it decides the entry of the key function of the selected input key 43 (Step S2503), recognizes the function of the decided input key 43, and supplies the input signal (Step S2504).

As mentioned above, the key entry is performed according to the two operations of: touching the input key 43 for a predetermined time and more or pushing it down with a predetermined pressure and more; and taking off the finger from the input key 43.

Even when the pressure sensitive key is used as the input key 43 of the operation key 41, the selecting processing of the key function of the input key 43 may be performed similarly to the case of the touch sensitive key, when detecting a predetermined pressure and more on the input key 43 for a predetermined time and more.

Although the above description has been made in the case where the selected state is decided when the pressure imposed on the input key 43 disappears, the selected entry may be decided when sensing a pressure less than the necessary pressure for pushing down the operation key 41 (the push button key) in the selected state (the pressure larger than the pressure sensed in the selecting processing).

As for the push button key function of the operation key 41, the corresponding key function is assigned and, for example, a key function for entering the determination for the final confirmation of the processing is assigned.

The key function corresponding to the push button key of the operation key 41 is defined for every processing condition in the above mentioned key setting table 222.

Although the above description has been made in the case where the key setting table 222 and the reverse key setting table 224 are previously defined and stored into the key function setting storing unit 220, only the key setting table 222 may be previously defined in order to assign the key functions in the open state and every time the mobile phone 1 is closed and the key functions are reversed, the key functions may be assigned, creating a reverse table with the key numbers reversed upside down.

(Concrete Operation in the First Embodiment)

A concrete example of the input operation according to the mobile phone 1 of the embodiment will be described.

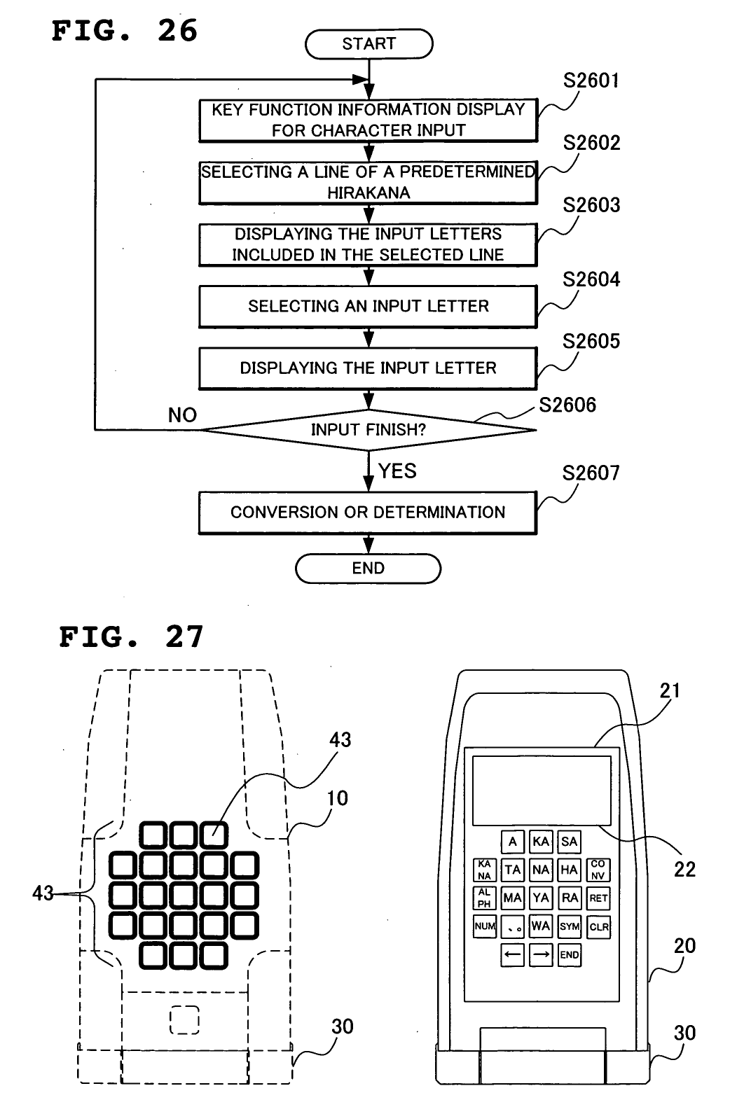

FIG. 26 is a flow chart showing a concrete example of the input operation according to the mobile phone 1.

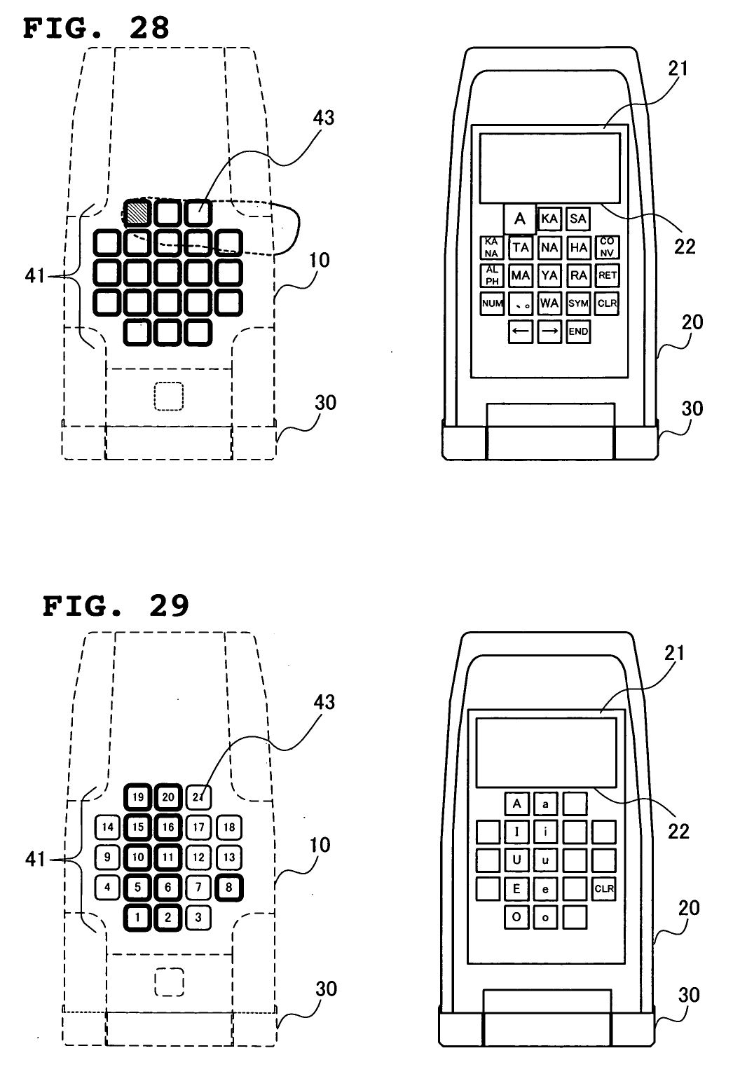

An operation of entering Japanese character, Hirakana, as an example of the detailed operation of the mobile phone 1 according to the first embodiment will be described with reference to FIG. 15, FIG. 18, FIG. 28 to FIG. 31.

FIG. 28 to FIG. 31 are views each showing a concrete example of a screen displayed on the display 21 of the mobile phone 1 according to the first embodiment; FIG. 28 shows the state of displaying the respective head letters in the “A ( [symbol] )” line to the “WA ( [symbol] )” line of the Japanese 50-character Hirakana syllabary, punctuation marks, arrow symbols, conversion (“CONV”), return (“RET”), clear (“CLR”), symbols (“SYM”) and end (“END”), character conversion into Kana, input conversion into English mode (“ALPH”), and input conversion into numeric (“NUM”), and FIG. 29 shows the state showing the “A ( [symbol] )” line and “a ( [symbol] )” line for Japanese input and a clear function.

Hereinafter, a description will be made, in the folding state of the mobile phone 1, in the case of entering the information while looking at the image of the input keys 43 and the key function display information 301 displayed on the display 21 through the operation of the input keys 43 of the operation body 10 positioned at the rear side of the display body 20.

When a user touches the input operation unit 40 by the finger, menu characters (key function information 301) indicating the processing functions executable by the mobile phone 1 appear overlapping the image 300 of the input keys 43, as illustrated in FIG. 15.

On the menu screen of FIG. 15, for example, when a user touches one of the corresponding input keys 43 arranged at the display position “mail” for a predetermine time and more and takes off the finger from the input key 43, the function about the mail is selected and determined, and in accordance with the processing condition of edit, the respective processing of send, edit, save, and delete that are the functions about the mail is displayed as illustrated in FIG. 18.

When the user touches one of the corresponding input keys 43 arranged at the display position “edit” in the mail for a predetermined time and more and takes off the finger from the input key 43, the function of “edit” is selected and decided, and in accordance with the processing condition of the edit, the key functions for entering the head letters from the “A ( [symbol] )” line to the “WA ( [symbol] )” line of Japanese 50-character Hirakana syllabary as illustrated in FIG. 27 are assigned and the key function information 301 (head Hirakana letters) indicating these key functions appears in accordance with each key of the input keys 43 (Step S2601).

In the state of FIG. 27, by a user's touching the input key 43 by the finger, he or she selects a Hirakana letter indicating the line including his or her desired letter (Step S2602). The letter is selected by touching the input key 43 for a predetermined time and more as mentioned above.

FIG. 28 shows the case where a user touches by the finger and selects the key corresponding to the display position of “A ( [symbol] )” that is the head letter of the “A ( [symbol] )” line of Hirakana, of the input keys 43.

In this case, the selected letter is highlighted as shown in FIG. 28. FIG. 28 shows the state in which, by touching the key corresponding to the display position of the Hirakana letter “A ( [symbol] )” for a predetermined time and more, the Hirakana letter “A ( [symbol] )” is selected and the display of the Hirakana letter “A ( [symbol] )” is highlighted.

In this way, a user can perform an input operation while confirming the letter he or she selected, looking at the letter highlighted on the display 21.

The emphasis display may be performed not only by enlargement but also by highlighting a selected letter clearer than the other portion.

As mentioned above, by selecting a Hirakana letter indicating a line including a letter a user wants to enter, the processing condition of the mobile phone 1 is switched and the key function display of the display 21 is switched, as illustrated in FIG. 29, with the Hirakana letters in the “A ( [symbol] )” line and the small ones in the small “a ( [symbol] )” line of Hirakana displayed corresponding to the respective keys of the input keys 43 (Step S2603).

A user selects a Hirakana letter he or she wants to enter by touching the input key 43 by the finger in FIG. 29 (Step S2604).

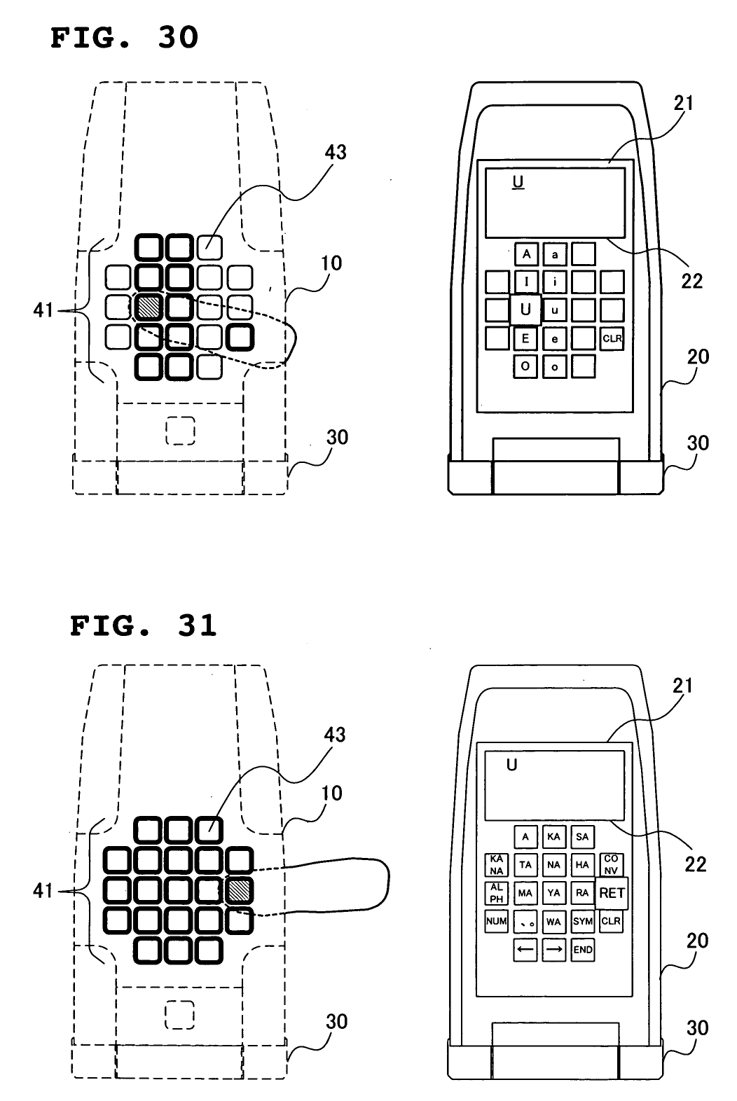

FIG. 30 shows the state in which a user selects the Hirakana letter “U ( [symbol] )” by touching the key corresponding to the display position of the Hirakana letter “U ( [symbol] )”, of the input keys 43, displayed on the display 21, while sliding his or her finger. In this case, the key function display of the selected letter is highlighted as shown.

Thus, the input Hirakana letter is displayed on the input display area 22 (Step S2605). FIG. 30 shows the state in which the Hirakana letter “U ( [symbol] )” is displayed on the input display area 22 of the display 21.

When entering another letter continuously (Step S2606), the processing is returned to the screen of the key function display of the Japanese 50-character Hirakana syllabary in Step S2601 and then, the above Steps are repeated to enter the other Hirakana letter.

Upon completion of the input, whether the input Hirakana letters are converted into Kanji or determined as they are as Hirakana is selected by touching the input key 43 (Step 2607).

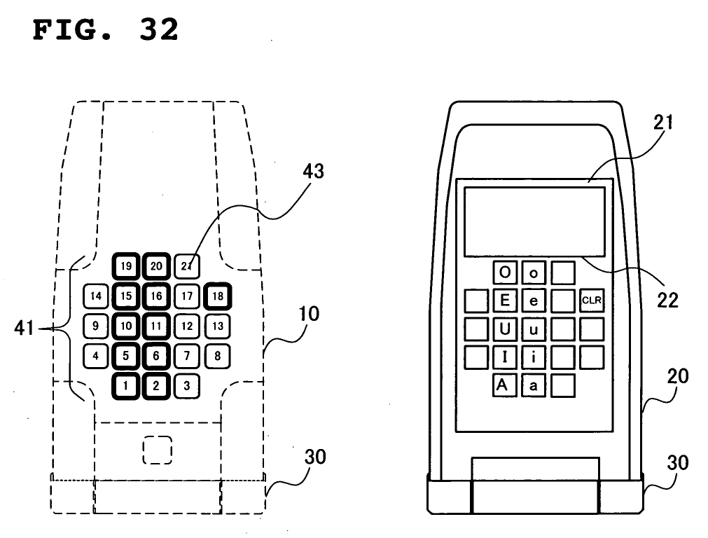

FIG. 31 shows the state in which the Hirakana letter “U ( [symbol] )” is determined after it is entered. It shows the state in which the underline attached to the Hirakana letter “U ( [symbol] )” displayed on the display area 22 disappears by the determination.

(Effect of the First Embodiment)

According to the above described embodiment, even in a folding state of the mobile phone 1, a user can use its original functions, performing an input operation while confirming the image of the input keys 43 and the key function display information displayed on the display 21, without concentrating on the input operation unit 40, similarly to in the open state of the mobile phone 1.

This is because the processing condition of the mobile phone 1 is checked by the processing condition checking unit 211 and the information of the key functions which are set by the key function setting unit 212 according to the processing contents corresponding to the checked processing condition is displayed on the display 21 overlapping the image of the input keys 43.

According to the embodiment, the mechanical structure of the input operation unit 40 can be simplified.

This is because the functions of the respective keys are not physically assigned to the respective input keys 43 but the key function setting unit 212 flexibly assigns the key functions to the respective keys of the input keys 43 depending on the current processing condition.

Namely, the processing condition checking unit 211 checks what kind of information is now acceptable by the mobile phone 1 and the key function setting unit 212 sets the key functions to the input keys 43 and/or the push button key, according to the processing condition checked by the processing condition checking unit 211. As the result, it is not necessary to have all the keys necessary for executing a plurality of functions provided in the mobile phone 1.

According to the embodiment, the degree of freedom in designing the input operation unit 40 increases.

This is because the conventional mobile phone 1 has to arrange a lot of keys necessary for executing a plurality of functions on the operation unit, for every function, and their operationality is restricted, which restricts the design of the input operation unit greatly, but according to the embodiment, various kinds of key functions can be freely assigned and these key functions are displayed on the display so as to perform an input operation, thereby decreasing a restriction on the design of the input operation unit.

Although the invention has been described taking some embodiments as an example, the invention is not restricted to the above embodiments but various modifications can be made within the scope of its technical sprit.

Although the above embodiments have been described in the case where when turning the mobile phone from the open state to the closed state, the assignment of the respective key functions to the respective input keys is reversed according to the definition in the reverse key table 224 prepared in every key setting table 222, the display of the key functions overlapping the image of the input keys 43 may be reserved on the display 21, instead of reversing the assignment of the key functions (not having the reverse key table 224).

For example, when the key functions are assigned as shown in FIG. 20, based on the key setting table 222 of FIG. 21, in the open state of the mobile phone, the arrangement of the respective input keys 43 on the operation key 41 is reversed upside down in the closed state. Under this condition, when the key function display processing unit 213 performs the display of the key functions again according to the key setting table 222, the display of the key functions overlapping the image of the input keys 43 is reversed. The state of reversing the display of the key functions is shown in FIG. 32.

As illustrated in FIG. 32, since the respective key functions defined in the key setting table 222 are displayed on the image of the input keys 43 according to the respective key numbers of the respective input keys 43, the display of the key functions is inverted to the display in the case of FIG. 20.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

What is claimed is:

1. A portable terminal having a display body including a display unit and an operation body including an input operation unit, comprising:
a key function assigning unit which assigns predetermined key function to a key portion provided on said input operation unit, depending on a current processing condition; and
a key function displaying unit which displays a contents of said key function assigned to said key portions, on said display unit.

2. A portable terminal in which a display body including a display unit and an operation body including an input operation unit are supported by a hinge, said portable terminal constituted in that
said display unit and said input operation unit are closed by folding together with the both rear surfaces, comprising:
a key function assigning unit which assigns predetermined key functions to a key portion provided on said input operation unit, depending on a current processing condition; and
a key function displaying unit which displays a contents of said key function assigned to said key portion, on said display unit.

3. The portable terminal according to claim 1, wherein said input operation unit comprises:
an operation key which works as a push button key;
wherein said key portion are provided on said operation key; and
wherein said key portion are capable of entering an information by touching a surface of said key portion or pressuring to said surface of said key portion.

4. The portable terminal according to claim 3, wherein said input operation unit has a plurality of said key portion; and
wherein a surface of said operation key is divided into a plurality of small divisions and said key portions are respectively formed in said small divisions.

5. The portable terminal according to claim 1, wherein said key function displaying unit displays said contents of said key function overlapping an image of said key portion.

6. The portable terminal according to claim 1, wherein said input operation unit has a plurality of said key portion; and
wherein each key function is assigned to each of said key portions or each predetermined area consisting of a combination of some key portions.

7. The portable terminal according to claim 2, wherein an arrangement of said key function assigned to said key portion either in an open position or in a close position of said display body and said operation body is inverted upside down when turning from the one position to the other position.

8. The portable terminal according to claim 2, wherein an image of said contents of said key function, which are assigned to said key portion either in an open position or in a close position of said display body and said operation body, is inverted upside down when turning from the one position to the other position.

9. The portable terminal according to claim 1, further comprising:
an input recognizing unit which recognizes an input operation on said key portion and supplies an input information corresponding to said key function assigned to said key portion.

10. The portable terminal according to claim 3, wherein said input operation unit accepts said key function assigned to said key portion when a touch or a pressure on said touched or pressed key portion disappears.

11. The portable terminal according to claim 3, wherein said input operation unit accepts said key function assigned to said key portion when said operation key is pushed down under a condition that said key portion is touched or pressurized.

12. The portable terminal according to claim 3, wherein said input operation unit selects said key function assigned to said key portion when a touch on said key portion for a predetermined time and more or a predetermined pressure and more on said key portion is detected, and accepts said selected key function assigned to said key portion when said operation key is pushed down.

13. The portable terminal according to claim 3, wherein said input operation unit selects said key function assigned to said key portion when a first pressure on said key portion is detected, and accepts said selected key function when a second pressure on said key portion more than said first pressure and less than a pressure necessary for pushing down said operation key is detected.

14. The portable terminal according to claim 3, wherein said input operation unit selects said key function assigned to said key portion when a touch on said key portion for a predetermined time and more or a predetermined pressure and more on said key portion is detected, and accepts said selected key function when said touch or said pressure on said key portion disappears.

15. The portable terminal according to claim 1, further comprising:
a plurality of tables which links said key portion with predetermined key function to be assigned to said key portion, depending on said processing condition;
wherein said key function assigning unit assigns said predetermined key functions based on said table corresponding to said processing condition.

16. The portable terminal according to claim 1, wherein said key function displaying unit highlights said contents of said key function displayed on said display unit.

17. An input device having an operation body including an input operation unit, said input device comprising:
a key function assigning unit which assigns predetermined key function to a key portion provided on said input operation unit, depending on the current processing condition.

18. The input device according to claim 17, wherein said input operation unit comprises:
an operation key which works as a push button key;
wherein said key portion are provided on said operation key; and
wherein said key portion are capable of entering an information by touching a surface of said key portion or pressuring to said surface of said key portion.

19. The input device according to claim 18, wherein said input operation unit has a plurality of said key portion; and
wherein a surface of said operation key is divided into a plurality of small divisions and said key portions are respectively formed in said small divisions.

20. The input device according to claim 17, wherein said input operation unit has a plurality of said key portion; and
wherein each key function is assigned to each of said key portions of said input operation unit or each predetermined area consisting of a combination of some key portions.

21. The input device according to claim 18, wherein said input operation unit accepts said key function assigned to said key portion when a touch or a pressure on said touched or pressed key portion disappears.

22. The input device according to claim 18, wherein said input operation unit accepts said key function assigned to said key portion when said operation key is pushed down under a condition that said key portion is touched or pressurized.

23. The input device according to claim 18, wherein said input operation unit selects said key function assigned to said key portion when a touch on said key portion for a predetermined time and more or a predetermined pressure and more on said key portion is detected, and accepts said selected key function when said operation key is pushed down.

24. The input device according to claim 18, wherein said input operation unit selects said key function assigned to said key portion when a first pressure on said key portion is detected, and accepts said selected key function when a second pressure on said key portion more than said first pressure and less than a pressure necessary for pushing down said operation key is detected.

25. The input device according to claim 18, wherein said input operation unit selects said key function assigned to said key portion when a touch on said key portion for a predetermined time and more or a predetermined pressure and more on said key portion is detected, and accepts said selected key function when said touch or said pressure on said key portion disappears.

26. The input device according to claim 17, comprising:
a plurality of tables which links said key portions with predetermined key functions to be assigned to said key portion, depending on said processing condition;
wherein said key function assigning unit assigns said predetermined key functions based on said table corresponding to said processing condition.

27. A method for controlling a portable terminal having a display body including a display unit and an operation body including an input operation unit, comprising:
assigning predetermined key function to a key portion provided on said input operation unit, depending on a current processing condition; and
displaying a contents of said key function assigned to said key portion, on said display unit.

28. A method for controlling a portable terminal in which a display body including a display unit and an operation body including an input operation unit are supported by a hinge, said portable terminal constituted in that said display unit and said input operation unit are closed by folding together with the both rear surfaces, said method comprising:
assigning predetermined key function to a key portion provided on said input operation unit, depending on a current processing condition; and
displaying a contents of said key function assigned to said key portion, on said display unit.

29. The method according to claim 27, further comprising:
displaying said contents of said key function overlapping an image of said key portion.

30. The method according to claim 27, further comprising:
assigning each key function to each of said key portions or each predetermined area consisting of a combination of some key portions.

31. The method according to claim 28, further comprising:
inverting an arrangement of said key function assigned to said key portion either in an open position or in a close position of said display body and said operation body upside down when turning from the one position to the other position.

32. The method according to claim 28, further comprising:
inverting an image of said contents of said key function which are assigned to said key portion either in an open position or in close position of said display body and said operation body upside down when turning from said one position to said other position.

33. The method according to claim 27, further comprising:
highlighting said contents of said key function displayed on said display unit.

34. A method for controlling a portable terminal having a display body including a display unit and an operation body including an input operation unit, comprising:
selecting a key function assigned to touched key portion which is provided on said input operation unit when a touch on said key portion for a predetermined time and more is detected; and
accepting said selected key function when said touch on said key portion disappears.

35. A method for controlling a portable terminal having a display body including a display unit and an operation body including an input operation unit, comprising:
selecting a key function assigned to pressurized key portion which is provided on said input operation unit when a predetermined pressure and more is detected; and
accepting said selected key function when said pressure on said key portion disappears.

36. A method for controlling a portable terminal having a display body including a display unit and an operation body including an input operation unit, comprising:
selecting a key function assigned to pressurized key portion which is provided on said input operation unit when a predetermined pressure is detected; and
accepting said selected key function when a pressure larger than said predetermined pressure on said key portion is detected.

37. The method according to claim 36, further comprising:
accepting said selected key function when a pressure less than a necessary pressure for pushing down said input operation unit working as a push button key.

38. A method for controlling a portable terminal having a display body including a display unit and an operation body including an input operation unit, comprising:
selecting a key function assigned to touched or pressurized key portion when a touch on said key portion for a predetermined time and more or a predetermined pressure and more is detected; and
accepting said selected key function when said input operation unit is pushed down.

39. The data input device of the portable terminal according to claim 21, comprising
a plurality of tables in each of which predetermined key functions to be assigned to said plurality of key portions are previously defined depending on said processing condition, in which
said key function assigning unit assigns said predetermined key functions based on the definition contents of said table corresponding to said processing condition.

40. The data input device of the portable terminal according to claim 22, in which
when a touch or a pressure is added to said key portion, said key function displaying unit highlights the contents of the key function of said key portion displayed on said display unit correspondingly to said key portion.

41. A data input supporting method of a portable terminal having a display body including a display unit and an operation body including an input operation unit, comprising:
assigning predetermined key functions to a plurality of key portions provided on said input operation unit, depending on the current processing condition; and
displaying the contents of the key functions assigned to said key portions, on said display unit.

42. A data input supporting method of a portable terminal in which a display body including a display unit and an operation body including an input operation unit are supported by a hinge in an opening and closing way,
said portable terminal constituted in that said display unit and said input operation unit are closed by folding together with the both rear surfaces into contact, said method comprising:
assigning predetermined key functions to a plurality of key portions provided on said input operation unit, depending on the current processing condition; and
displaying the contents of the key functions assigned to said key portions, on said display unit.

43. The data input supporting method of the portable terminal according to claim 41, in which
in said key function assignment,
the predetermined key functions are assigned to the key portions and a push button function of said operation key forming said input operation unit, and
in said key function display, the contents of said key functions are displayed overlapping the image of the key portions of said operation key.

44. The data input supporting method of the portable terminal according to claim 41, in which
in said key function assignment, each key function is assigned to each of the key portions of said input operation unit or each predetermined area consisting of a combination of some key portions.

45. The data input supporting method of the portable terminal according to claim 41, in which
arrangement of said key functions assigned to said key portions either in an open state of said display body and said operation body or in a closed state is inverted upside down when turning from the one state to the other state.

46. The data input supporting method of the portable terminal according to claim 42, in which
display of the contents of said key functions on said display unit, which are assigned to said key portions either in an open state of said display body and said operation body or in a closed state, is inverted upside down when turning from the one state to the other state.

47. The data input supporting method of the portable terminal according to claim 42, in which
when a touch or a pressure is added to said key portion, the contents of said key function of said key portion displayed on said display unit correspondingly to said key portion is highlighted.

48. The data input supporting method of the portable terminal according to claim 42, in which
said image is transparently displayed on said display unit at a position corresponding to the key portions of said input operation unit.

49. A data input supporting program executed on a portable terminal having a display body including a display unit and an operation body including an input operation unit, which makes said portable terminal execute:
a function of assigning predetermined key functions to a plurality of key portions provided on said input operation unit, depending on the current processing condition; and
a function of displaying the contents of the key functions assigned to said key portions, on said display unit.

50. A data input supporting program executed on a portable terminal in which a display body including a display unit and an operation body including an input operation unit are supported by a hinge in an opening and closing way, which makes said portable terminal
constituted in that said display unit and said input operation unit are closed by folding together with the both rear surfaces into contact, execute:
a function of assigning predetermined key functions to a plurality of key portions provided on said input operation unit, depending on the current processing condition; and
a function of displaying the contents of the key functions assigned to said key portions, on said display unit.

51. The data input supporting program according to claim 49, in which
said key function assignment function
assigns the predetermined key functions to the key portions and a push button function of said operation key forming said input operation unit, and
said key function displaying function displays the contents of said key functions overlapping the image of the key portions of said operation key.

52. The data input supporting program according to claim 49, wherein
said key function assignment function assigns each key function to each of the key portions of said input operation unit or each predetermined area consisting of a combination of some key portions.

53. The data input supporting program according to claim 50, further comprising
a function of inverting upside down arrangement of said key functions which are assigned to said key portions either in an open state of said display body and said operation body or in a closed state, when turning from the one state to the other state.

54. The data input supporting program according to claim 50, further comprising
a function of inverting upside down display of the contents of said key functions on said display unit, which are assigned to said key portions either in an open state of said display body and said operation body or in a closed state, when turning from the one state to the other state.

55. The data input supporting program according to claim 49, further comprising
a function of transparently displaying said image on said display unit at a position corresponding to the key portions of said input operation unit.

56. A data input method of a portable terminal having a display body including a display unit and an operation body including an input operation unit, comprising the steps of:
selecting a key function assigned to a touched key portion when detecting a touch on said key portion for a predetermined time and more, of a plurality of key portions provided on said input operation unit, and
determining said selected key function when detecting that there disappears the touch on said key portion.

57. A data input method of a portable terminal having a display body including a display unit and an operation body including an input operation unit, comprising the steps of:
selecting a key function assigned to a pushed key portion when detecting a predetermined pressure and more on one of a plurality of key portions provided on said input operation unit, and
determining said selected key function when detecting that the pressure on said key portion disappears.

58. A data input method of a portable terminal having a display body including a display unit and an operation body including an input operation unit, comprising:
selecting a key function assigned to a pushed key portion when detecting a predetermined pressure on one of a plurality of key portions provided on said input operation unit, and
determining said selected key function when detecting a pressure larger than said predetermined pressure on said key portion.

59. The data input method of the portable terminal according to claim 58, comprising
determining said selected key function when detecting a pressure less than a necessary pressure for pushing down said input operation unit working as a push button key with said predetermined pressure and more.

60. A data input method of a portable terminal having a display body including a display unit and an operation body including an input operation unit, comprising:
selecting a key function assigned to a touched or pushed key portion when detecting a touch on said key portion for a predetermined time and more or detecting a predetermined pressure and more on said key portion, of a plurality of key portions provided on said input operation unit working as a push button key, and
determining said selected key function when said input operation unit is pushed down.
